(19) United States
(12) Patent Application Publication
(10) Pub. No.: US 2014/0023899 A1
(43) Pub. Date: Jan. 23, 2014

(54) SECONDARY BATTERY, AND CURRENT COLLECTOR TERMINAL STRUCTURE OF SECONDARY BATTERY

(71) Applicant: Hiroyuki TANAKA, Nagakute-shi (JP)

(72) Inventor: Hiroyuki TANAKA, Nagakute-shi (JP)

(73) Assignee: TOYOTA JIDOSHA KABUSHIKI KAISHA, Toyota-shi (JP)

(21) Appl. No.: 13/933,829

(22) Filed: Jul. 2, 2013

(30) Foreign Application Priority Data
Jul. 18, 2012 (JP) 2012-159529

(51) Int. Cl. H01M 2/26; H01M 10/0587

(52) U.S. Cl. CPC H01M 2/263; H01M 10/0587
USPC 429/94

(57) ABSTRACT

A secondary battery has a wound electrode body, and two current collector terminals connected to opposite current collector foils of the electrode body. Bound portions in which the current collector foils are bound are opposed to each other in a compression direction in which the wound electrode body is compressed. Each current collector terminal has a current-collecting portion that has a solid structure and is inserted between the opposed bound portions for connection with the electrode body, and a current-carrying portion formed integrally with the current-collecting portion. The width of the current-carrying portion is substantially equal to the thickness of the electrode body in the compression direction, and the current-carrying portion extends along a corresponding one of opposite end faces of the electrode body as viewed in the direction of the winding center axis.

### INCORPORATION BY REFERENCE

The disclosure of Japanese Patent Application No. 2012-159529 filed on Jul. 18, 2012 including the specification, drawings and abstract is incorporated herein by reference in its entirety.

### BACKGROUND OF THE INVENTION

1. Field of the Invention

The invention relates to a secondary battery, and a current collector terminal structure of a secondary battery, and particularly to a technology of connecting an electrode body of the secondary battery with current collector terminals.

2. Description of Related Art

One type of secondary battery is known in which long current collecting foils are wound to form an electrode body, and current collector terminals are connected to end portions of the electrode body (see, for example, Japanese Patent Application Publication No. 2011-165437 (JP 2011-165437 A)).

According to the above-identified publication, while a support plate for holding the current collecting foils is inserted between bound portions formed by binding the current collector foils in the electrode body, the bound portions are sandwiched between current collector plates and the support plate, so that the electrode body is connected to the current collector terminals. However, in the case where the secondary battery is constructed as described above, the support plate inserted between the bound portions is needed, resulting in increases in the number of components and the number of process steps.

### SUMMARY OF THE INVENTION

The invention provide a secondary battery and a current collector terminal structure thereof, in which current collector terminals can be connected to end portions of an electrode body, without increasing the number of components and the number of process steps.

According to a first aspect of the invention, a secondary battery includes an electrode body formed by winding a positive electrode, a negative electrode and a separator, about a winding center axis, into a wound assembly, and by compressing the wound assembly in a direction perpendicular to the winding center axis, the electrode body having current collector foils located in opposite end portions thereof as viewed in the direction of the winding center axis, and two current collector terminals respectively connected to the current collector foils. In the secondary battery, the electrode body includes a plurality of bound portions in which the current collector foils are bound, and the bound portions are disposed at positions that are opposed to each other in a compression direction in which the wound assembly is compressed. Each of the two current collector terminals has a current-collecting portion that has a solid structure and is inserted between the bound portions opposed to each other for connection with the electrode body, and a current-carrying portion formed integrally with the current-collecting portion. The current-carrying portion has a width that is substantially equal to a thickness of the electrode body as measured in the compression direction, and is arranged so as to extend along a corresponding one of opposite end faces of the electrode body as viewed in the direction of the winding center axis.

According to a second aspect of the invention, a current collector terminal structure of a secondary battery for connecting an electrode body formed by winding a positive electrode, a negative electrode and a separator, about a winding center axis, into a wound assembly, and by compressing the wound assembly in a direction perpendicular to the winding center axis, with current collector terminals respectively connected to current collector , foils located in opposite end portions of the electrode body as viewed in the direction of the winding center axis, is provided. In the current collector terminal structure, the electrode body includes a plurality of bound portions in which the current collector foils are bound, and the bound portions are disposed at positions that are opposed to each other in a compression direction in which the wound assembly is compressed. Each of the current collector terminals has a current-collecting portion having a solid structure, and a current-carrying portion formed integrally with the current-collecting portion. The current-carrying portion has a width that is substantially equal to a thickness of the electrode body as measured in the compression direction, and is arranged so as to extend along a corresponding one of opposite end faces of the electrode body as viewed in the direction of the winding center axis. The current-collecting portion is disposed between the bound portions opposed to each other, so as to be connected to the electrode body.

According to the invention, it is possible to connect the current collector terminals to end portions of the electrode body, without increasing the number of components and the number of process steps.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a front, cross-sectional view showing the schematic construction of a secondary battery according to one embodiment of the invention;

FIG. 2 is a cross-sectional view taken along line X-X in FIG l; and

FIG. 3 is a cross-sectional view showing a condition of connection between an electrode body and current collector terminals.

### DETAILED DESCRIPTION OF EMBODIMENTS

One embodiment of the invention will be described. It is to be understood that the technical scope of the invention is not limited to the embodiment as described below, but extensively covers the full scope of a technical concept that is truly intended to be covered by the invention, which concept will become apparent from the matters described in this specification and drawings. In each of the drawings, directions used for explanation in this specification are denoted by arrows.

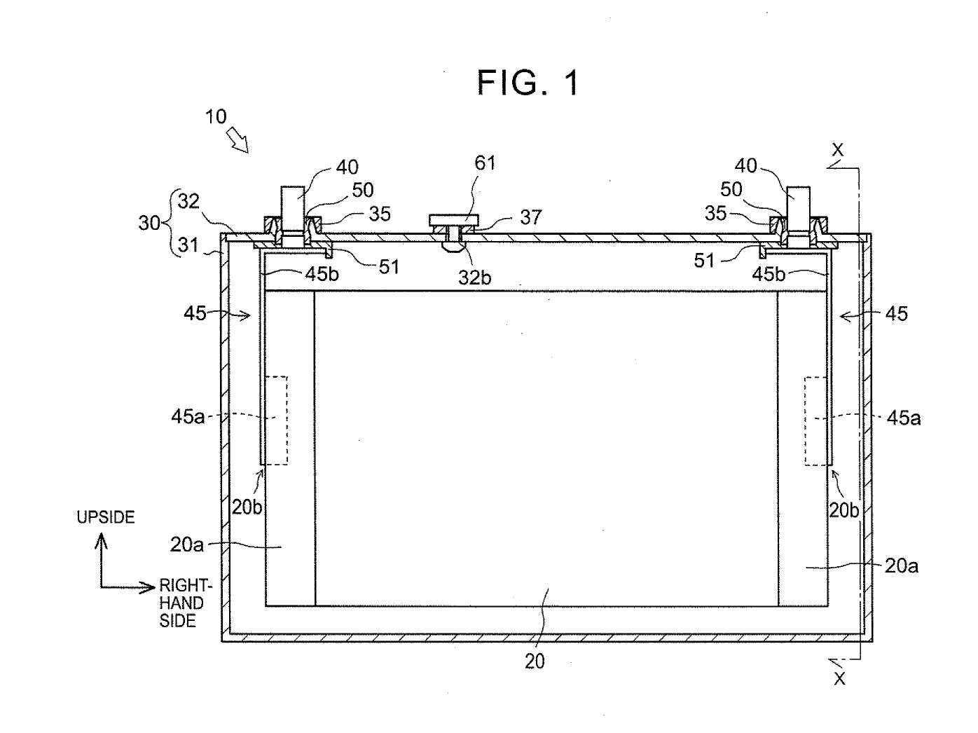

Referring to FIG. 1, the schematic construction of a battery 10 as a secondary battery according to one embodiment of the invention will be described. The battery 10 of this embodiment is a sealed lithium-ion secondary battery, and is used as the one installed on a vehicle, for example. The object to which this invention is applied is not limited to lithium-ion secondary batteries, but may also be applied to other secondary batteries, such as nickel-metal-hydride batteries.

The battery 10 includes an electrode body 20, an outer package 30 as a battery container in which the electrode body 20 is housed, and two exterior terminals 40, 40 on the positive electrode side and negative electrode side, which protrude outward from the outer package 30. The battery 10 further includes two current collector terminals 45, 45 that connect the electrode body 20 with the external terminals 40, 40, and insulating members 50, 51 interposed between each of the external terminals 40 and each of the current corrector terminals 45, and the outer package 30.

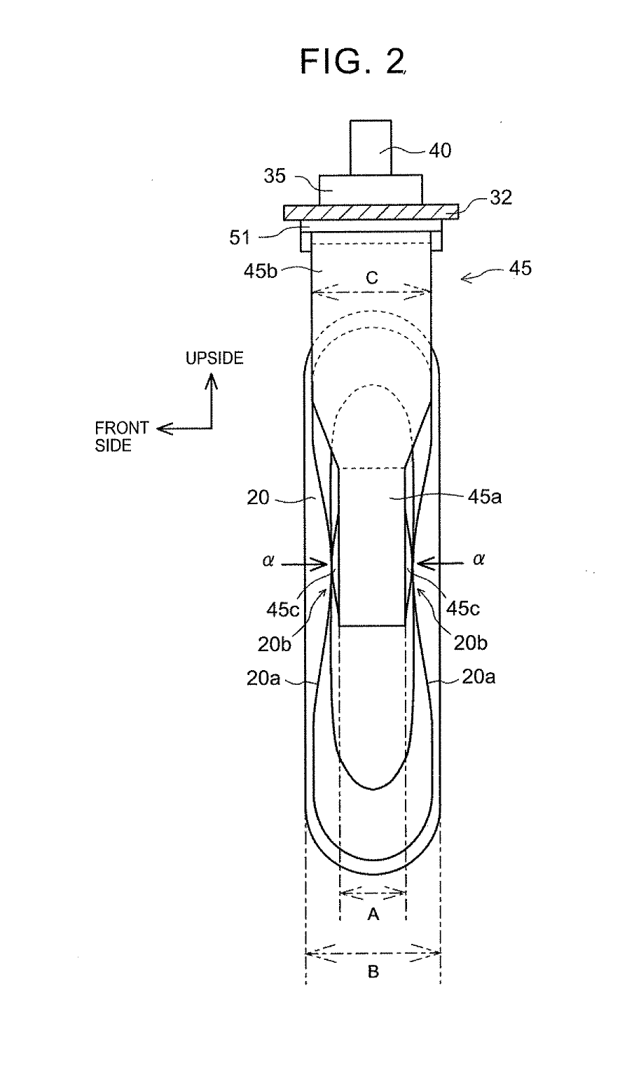

The electrode body 20 is formed by winding long positive electrode and negative electrode and a separator, about a winding center axis that extends in the lateral direction, into a wound electrode assembly, and then compressing the wound electrode assembly in a direction perpendicular to the winding center axis (i.e., in a front-back direction in this embodiment). The electrode body 20 thus formed is impregnated with an electrolyte within the outer package 30. When chemical reactions occur in the electrode body 20 at the time of charge or discharge of the battery 10 (more strictly, when ions move between the positive electrode and the negative electrode via the electrolyte), electric current starts flowing. In the electrode body 20, current collector foils 20a, 20a are located on the positive-electrode side and the negative-electrode side (in this embodiment, on both of the right-hand side and the left-hand side), respectively. The electrode body 20 includes bound portions 20b, 20b formed by binding the current collector foils 20a, 20a, at its portions where the positive-electrode-side and negative-electrode-side current collector foils 20a, 20a are located, such that two bound portions 20b, 20b (a total of four bound portions 20b on the right-hand and left-hand sides) are formed in each current collector foil 20a, at its positions opposed to each other in the front-back direction, namely, in the compression direction in which the electrode body 20 is compressed (see FIG. 2). In this embodiment, the bound portions 20b, 20b are formed at two locations that are opposed to each other, so that the width of the current collector foil 20a as measured in the front-back direction is reduced. Also, the interval between the bound portions 20b, 20b (width A in FIG. 2) is made equal to about a half of the thickness of the electrode body 20 as measured in the compression direction (i.e., the width of the electrode body 20 as measured in the front-back direction, or width B in FIG. 2), so that the size (width) of the current collector foil 20a is advantageously minimized.

The outer package 30 serving as the battery container is a rectangular canister having a storage portion 31 and a lid 32, and is formed such that the width of the outer package 30 as measured in the front-back direction is smaller than the dimensions thereof as measured in the vertical direction and lateral direction. The storage portion 31 is a rectangular cylindrical member that has a bottom at one end and is open at the other end, and the electrode body 20 is housed in the storage portion 31. The lid 32 is a flat-plate like member that is shaped in accordance with the shape of the opening of the storage portion 31, and is joined to the storage portion 31 so as to close the opening of the storage portion 31. A spout hole 32b through which the electrolyte is poured into the storage portion 31 is open on a portion of the lid 32 between its portions where the external terminals 40, 40 are inserted as will be described later.

The external terminals 40, 40 are mounted in right and left portions of the lid 32, respectively, such that a part of each external terminal 40 protrudes outwardly of the battery 10, from the outer surface of the lid 32. The external terminals 40, 40 are electrically connected to the positive electrode and negative electrode of the electrode body 20, via the current collector terminals 45, 45. The external terminals 40, 40 and the current collector terminals 45, 45 function as a current-carrying path through which electric power stored in the electrode body 20 is delivered to the outside of the battery 10, or electric power is fed from the outside of the battery 10 into the electrode body 20.

Each of the current collector terminals 45, 45 is connected at its lower end to the corresponding one of the positive-electrode-side and negative-electrode-side current collector foils 20a, 20a that extend from the electrode body 20. In other words, the current collector terminals 45, 45 are respectively connected to the electrode body 20, at opposite end portions of the electrode body 20 as viewed in the direction of the winding center axis (the lateral direction in this embodiment). Also, each of the current collector terminals 45, 45 is connected at its upper end to the corresponding one of the external terminals 40, 40. Namely, the current collector terminals 45, 45 electrically connect the electrode body 20 with the external terminals 40, 40, The positive-electrode-side current collector terminal 45 may be made of a material, such as aluminum, and the negative-electrode-side current collector terminal 45 may be made of a material, such as copper.

A fixing member 35 is fitted and mounted on an outer circumferential surface of each of the external terminals 40, so that the external terminal 40 is fixed to the lid 32 via the insulating members 50, 51 interposed therebetween, while being insulated from the lid 32. The insulating members 50, 51 are preferably made of a material that is excellent in a high-temperature creep characteristic, namely, a material having long-term creep resistance to the heating and cooling cycle of the battery 10. For example, the insulating members 50, 51 are made of PFA (perfluoro alkoxy ethylene).

A portion of each of the external terminals 40, 40 which protrudes outwardly of the battery 10 is subjected to threading by thread rolling, so that a bolt portion is formed in the external terminal 40. When the battery 10 is actually used, bus bars, connecting terminals of an external device, or the like, are fastened and fixed to the bolt portions of the external terminals 40, 40. Since fastening torque is applied to the external terminals 40, 40 during fastening and fixing, and external force is applied in the axial direction to the external terminals 40, 40 due to screwing, the external terminals 40, 40 are preferably made of a high-strength material, such as iron.

The spout hole 32b is formed so as to be open on the lid 32 as described above, such that the hole 32b is located between one of the external terminals 40 and the other external terminal 40. The spout hole 32b is a through-hole having a given inside diameter, and extends through the lid 32 in the thickness direction of the lid 32. The spout hole 32b is used for pouring the electrolyte into the interior of the outer package 30 in which the electrode body 20 is housed in advance. As shown in FIG. 1, a blind rivet 61 as a sealing member, and a gasket 37, are attached to the spout hole 32b.

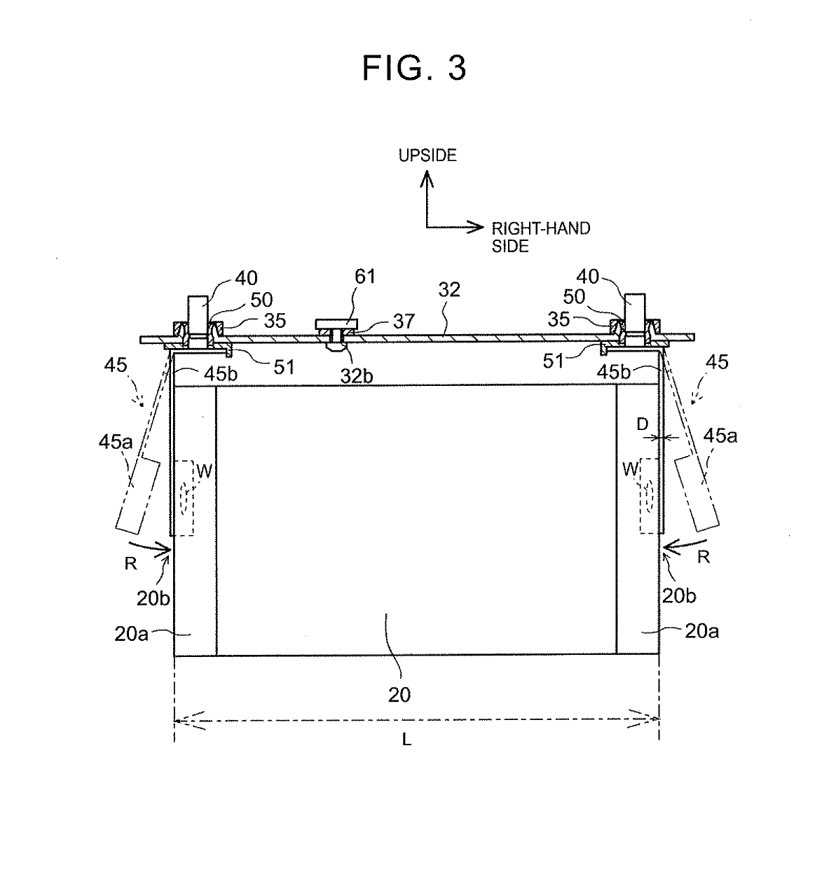

Referring next to FIG. 2 and FIG. 3, the arrangement for connecting the current collector terminals 45 to the electrode body 20 will be described. In FIG. 2 and FIG. 3, the storage portion 31 is not illustrated. Each of the current collector terminals 45 has a current-collecting portion 45a having a solid structure, and a plate-like current-carrying portion 45b linked to the current-collecting portion 45a, and the current-collecting portion 45a and the current-carrying portion 45b are integrally formed by press. The current-collecting portion 45a is formed in the shape of a block that protrudes inwards from the current-carrying portion 45b, and is inserted between the bound portions 20b, 20b, to be connected to the electrode body 20. The width of the current-collecting portion 45a as measured in the front-back direction is made substantially equal to the interval between the bound portions 20b, 20b (width A in FIG. 2). Also, as shown in FIG. 2, the current-collecting portion 45a of this embodiment is formed with projections 45c, 45c that protrude from front and rear surfaces of the current-collecting portion 45a.

The width of the current-carrying portion 45b (width C in FIG. 2) is made substantially equal to the thickness of the electrode body 20 as measured in the compression direction (i.e., the width of the electrode body 20 as measured in the front-back direction, or width B in FIG. 2). Here, “substantially equal to” means “equal to such an extent that the current-carrying portion 45b does not protrude from the electrode body 20 in the thickness direction”. Namely, the current-carrying portion 45b and the electrode body 20 are formed so that the width C is equal to or slightly smaller than the width B. The current collector terminals 45, 45 are positioned so as to extend along the opposite end faces of the electrode body 20 as viewed in the lateral direction or the direction of the winding center axis.

The current-carrying portion 45b is designed to have a small thickness (thickness as measured in the lateral direction, width D in FIG. 3) so that the length of the electrode body 20 as measured in the lateral direction (width L in FIG. 3) is not reduced. In other words, the thickness D of the current-carrying portion 45b is reduced, so that the size of the battery 10 is not increased when the required lateral length of the electrode body 20 is ensured. More specifically, the thickness D of the current-carrying portion 45b is controlled to be equal to or larger than 0.2 mm and equal to or smaller than 1.0 mm. In this embodiment, the width B of the current-carrying portion 45b is made substantially equal to the thickness of the electrode body 20, and is made larger than the width A of the current-collecting portion 45a, so that the desired current-carrying cross-sectional area is assured even if the thickness D of the current-carrying portion 45b is made small.

When the current collector terminal 45 is connected to the electrode body 20, the current-carrying portion 45b and the current-collecting portion 45a are bent while being rotated about an upper end portion of the current collector terminal 45 which is connected to the external terminal 40, and the current-collecting portion 45a is inserted between the bound portions 20b, 20b, as indicated by arrow R in FIG. 3. Then, as indicated by arrow a in FIG. 3, spot welding is performed on the outer sides of the bound portions 20b, 20b, with spot welding electrodes between which the bound portions 20b, 20b and the current-collecting portion 45a (a region W indicated by a broken line in FIG. 3) are sandwiched. In this embodiment, the projections 45c, 45c are formed on the front and rear surfaces of the current-collecting portion 45a; therefore, electric current is passed concentratedly through the projections 45c, 45c, to provide an increased current density, or so-called projection effect. In this connection, ultrasonic welding may be used in place of spot welding.

As described above, according to this embodiment, support plates for holding the current collector foils 20a are not needed when the electrode body 20 and the current collector terminals 45 are connected in the battery 10. Therefore, the number of components and the number of process steps are not increased.

According to this embodiment, the current-collecting portion 45a having a solid structure is inserted between the bound portions 20b, 20b, and spot welding is performed on the outer sides of the bound portions 20b, 20b, with the spot welding electrodes between which the current-collecting portion 45a and the bound portions 20b, 20b are sandwiched. With this arrangement, there is no need to perform welding at each of the opposed bound portions 20b, 20b, and the opposed bound portions 20b, 20b and the current-collecting portion 45a can be welded together, in a single spot-welding step. More specifically, in the case where the current-collecting portion consists of a hollow member (e.g., a U-shaped member as seen in a planar view), welding needs to be performed at each of the opposed bound portions 20b, 20b, whereas, in this embodiment, the current-collecting portion 45a has a solid structure, and therefore, the bound portions 20b, 20b and the current-collecting portion 45a can be welded together in a single welding step.

What is claimed is:

1. A secondary battery comprising:
an electrode body formed by winding a positive electrode, a negative electrode and a separator, about a winding center axis, into a wound assembly, and by compressing the wound assembly in a direction perpendicular to the winding center axis, the electrode body having current collector foils located in opposite end portions thereof as viewed in the direction of the winding center axis; and
two current collector terminals respectively connected to the current collector foils, wherein:
the electrode body includes a plurality of bound portions in which the current collector foils are bound, the bound portions being disposed at positions that are opposed to each other in a compression direction in which the wound assembly is compressed; and
each of the two current collector terminals has a current-collecting portion and a current-carrying portion, the current-collecting portion having a solid structure and being disposed between the bound portions opposed to each other for connection with the electrode body, the current-carrying portion being formed integrally with the current-collecting portion, the current-carrying portion having a width that is substantially equal to a thickness of the electrode body as measured in the compression direction, and the current-carrying portion being arranged so as to extend along a corresponding one of opposite end faces of the electrode body as viewed in the direction of the winding center axis.

2. The secondary battery according to claim 1, wherein the width of the current-carrying portion is equal to or smaller than the thickness of the electrode body.

3. The secondary battery according to claim 1, wherein each of the current collector terminals includes projections that protrude from front and rear surfaces of the current-collecting portion in the compression direction.

4. A current collector terminal structure of a second battery, for connecting an electrode body with current collector terminals, the electrode body being formed by winding a positive electrode, a negative electrode and a separator, about a winding center axis, into a wound assembly, and by compressing the wound assembly in a direction perpendicular to the winding center axis, and the current collector terminals being respectively connected to current collector foils located in opposite end portions of the electrode body as viewed in the direction of the winding center axis, wherein:
the electrode body includes a plurality of bound portions in which the current collector foils are bound, the bound portions being disposed at positions that are opposed to each other in a compression direction in which the wound assembly is compressed; and
each of the current collector terminals has a current-collecting portion and a current-carrying portion, the current-collecting portion having a solid structure, the current-carrying portion being formed integrally with the current-collecting portion, the current-carrying portion having a width that is substantially equal to a thickness of the electrode body as measured in the compression direction, the current-carrying portion being arranged so as to extend along a corresponding one of opposite end faces of the electrode body as viewed in the direction of the winding center axis, and the current-collecting portion being disposed between the bound portions opposed to each other, so as to be connected to the electrode body.

5. The current collector terminal structure according to claim 4, wherein the width of the current-carrying portion is equal to or smaller than the thickness of the electrode body.

6. The current collector terminal structure according to claim 4, wherein each of the current collector terminals includes projections that protrude from front and rear surfaces of the current-collecting portion in the compression direction.
